(19) United States
(12) Patent Application Publication
(10) Pub. No.: US 2024/0152414 A1
(43) Pub. Date: May 9, 2024

(54) SYSTEM AND METHOD FOR PROVIDING OUTBOX SERVICE

(71) Applicant: JPMorgan Chase Bank, N.A., New York, NY (US)

(72) Inventor: Hoang VO, Little Elm, TX (US)

(73) Assignee: JPMorgan Chase Bank, N.A., New York, NY (US)

(21) Appl. No.: 17/980,048

(22) Filed: Nov. 3, 2022

(51) Int. Cl. G06F 9/54; H04L 67/10

(52) U.S. Cl. CPC G06F 9/546; H04L 67/10

(57) ABSTRACT

A method and system for providing outbox services separate from a source application in a distributed application system are disclosed. The method includes performing, by the source application, an operation; writing, onto an operation store, data associated with the operation performed by the source application; writing, onto an event store, an event corresponding to the data; receiving, by an outbox transporter and from the event store, the event; and publishing, to a target and by the outbox transporter, the event received by the outbox transport processor, in which the outbox transporter is separate from the source application.

### TECHNICAL FIELD

This disclosure generally relates to a system and method for providing separate outbox services for removal of application dependencies and streamlining of event publications.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

In a distributed applications system, many separate applications work together over a network. In order to facilitate such a working relationship, a source application may publish an event for an operation performed to notify other applications, systems and/or services. Based on the event published by a messaging service provided on the respective source application, one or more downstream applications may perform corresponding operations. However, often, in such a distributed application system, a large number of hard dependencies may exist, such that application downtime may increase any time any of the dependencies fail. Accordingly, it may be desirable to remove as many hard dependencies in a critical data path to reduce application downtime and to improve resiliency. However, once hard dependencies are removed or separated, problems of transactionality that applications must support in the storing of critical business data, and forwarding of that data to downstream applications, systems and/or services are introduced. However, existing solutions may be subject to out of order publishing of events, leading to incorrect order of execution by downstream systems, applications and/or services. Further, when an application is restarted from a downed state, queued or buffered events may then polled and processed for publishing. However, a large quantity of events that were queued or buffered during downtime may cause a bottleneck in publishing of events, such that some of the events may eventually go unpublished as the current system may be unable to timely process the backlogged events, leading to obscure operations in the downstream systems, applications and/or services.

### SUMMARY

According to an aspect of the present disclosure, a method for performing outbox services separate from a source application in a distributed application system is provided. The method includes performing, by the source application, an operation; writing, onto an operation store, data associated with the operation performed by the source application; writing, onto an event store, an event corresponding to the data; receiving, by an outbox transporter and from the event store, the event; and publishing, to a target and by the outbox transporter, the event received by the outbox transport processor, in which the outbox transporter is separate from the source application.

According to another aspect of the present disclosure, in response to receiving the event by the target, transmitting a query to an outbox recon processor, the query requesting a number of events written to the event store and a number of events published during a specified time period, in which the outbox recon processor is separate from the source application.

According to another aspect of the present disclosure, comparing the number of events written to the event store and the number of events published during the specified time period; and when the number of events published does not match with the number of events written for the specified time period, identifying one or more events that were not published and controlling the outbox transport processor to publish the one or more events, and controlling the outbox transport processor to publish the one or more events identified by the outbox recon processor.

According to yet another aspect of the present disclosure, controlling an outbox replay processor to replay one or more events stored in the event store to the target.

According to another aspect of the present disclosure, the event received by the outbox transport processor is streamed to the target in a sequential manner.

According to a further aspect of the present disclosure, the event is written to the event store in a sequential manner with time stamp information.

According to yet another aspect of the present disclosure, the event is published in a sequential manner according to the time stamp information associated with the event.

According to a further aspect of the present disclosure, the source application does not receive or read information from the event store.

According to another aspect of the present disclosure, the source application does not receive or read information from the operation store.

According to a further aspect of the present disclosure, the event store has a buffer for receiving a plurality of events to the event store, and the outbox transport processor sequentially publishes one event at a time in a stream.

According to another aspect of the present disclosure, a system for performing outbox services separate from a source application in a distributed application system is disclosed. The system includes the source application that performs an operation; an operation store that stores data associated with the operation performed by the source application; an event store that stores an event corresponding to the data stored in the operation store; an outbox transporter that receives, from the event store, the event; and publishes, to a target, the received event, in which the outbox transporter is separate from the source application.

According to a further aspect of the present disclosure, the system further includes an outbox recon processor. The outbox recon processor, in response to receiving the event by the target, the target transmits a query to the outbox recon processor, the query requesting a number of events written to the event store and a number of events published during a specified time period. The outbox recon processor is separate from the source application.

According to a further aspect of the present disclosure, the outbox recon processor compares the number of events written to the event store and the number of events published during the specified time period; and when the number of events published does not match with the number of events written for the specified time period, identifies one or more events that were not published and controls the outbox transport processor to publish the one or more events, and controls the outbox transport processor to publish the one or more events identified by the outbox recon processor.

According to a further aspect of the present disclosure, the system further includes an outbox replay processor that replays one or more events stored in the event store to the target.

According to a further aspect of the present disclosure, the event received by the outbox transport processor is streamed to the target in a sequential manner.

According to a further aspect of the present disclosure, the event is written to the event store in a sequential manner with time stamp information.

According to a further aspect of the present disclosure, the event is published in a sequential manner according to the time stamp information associated with the event.

According to a further aspect of the present disclosure, the source application does not receive or read information from the event store.

According to a further aspect of the present disclosure, the source application does not receive or read information from the operation store.

According to a further aspect of the present disclosure, the event store has a buffer for receiving a plurality of events to the event store, and the outbox transport processor sequentially publishes one event at a time in a stream.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an outbox system in accordance with an exemplary embodiment.

FIG. 2 illustrates an exemplary diagram of a network environment with an outbox system in accordance with an exemplary embodiment.

FIG. 3 illustrates a system diagram for implementing an outbox system in accordance with an exemplary embodiment.

FIG. 4A illustrates a desired method to be performed to remove hard dependencies in a distributed application environment.

FIG. 4B illustrates a pattern-based solution in accordance with a related technology.

FIG. 4C illustrates a system flow diagram utilizing an outbox system in accordance with an exemplary embodiment.

FIG. 5 illustrates a system flow diagram in a distributed application environment in accordance with an exemplary embodiment.

FIG. 6 illustrates a process flow for performing an outbox transportation operation in accordance with an exemplary embodiment.

FIG. 7 illustrates a process flow for performing an outbox recon operation in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

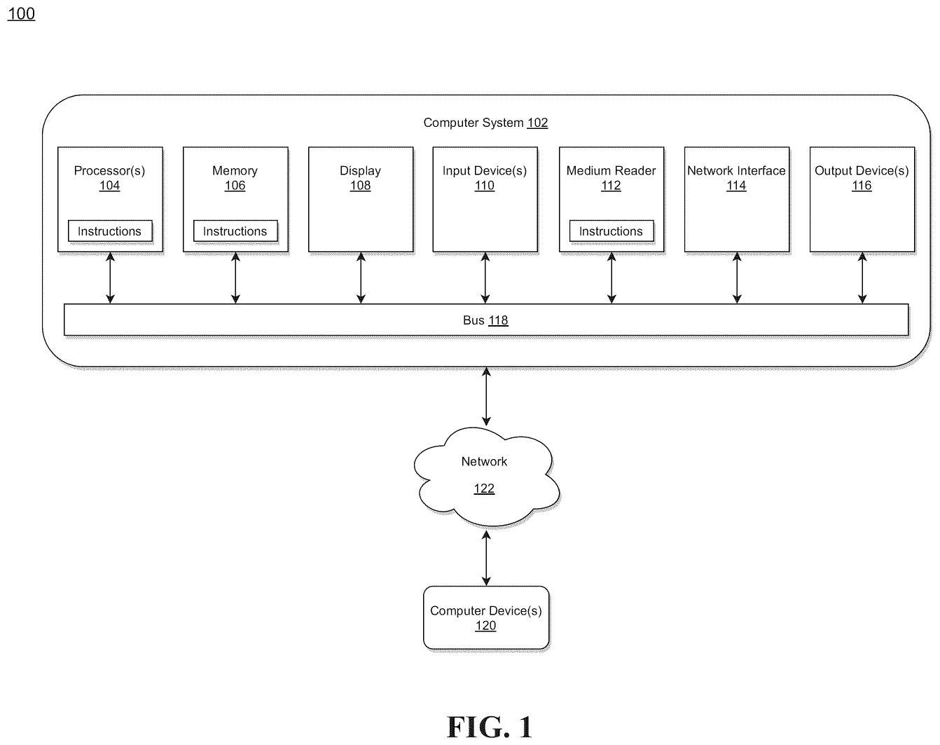

FIG. 1 illustrates a computer system for implementing an outbox system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

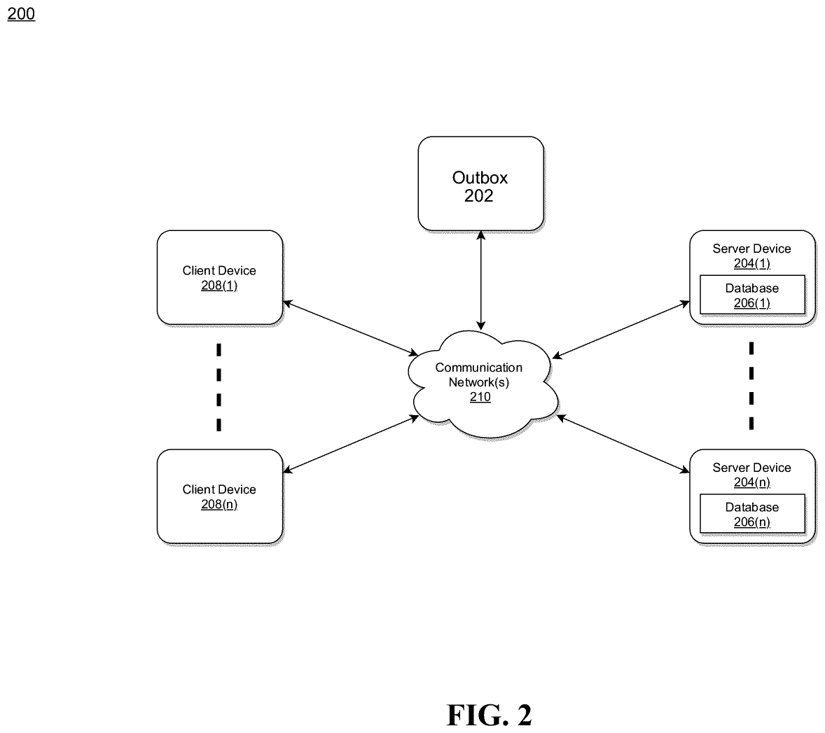

FIG. 2 illustrates an exemplary diagram of a network environment with an outbox system in accordance with an exemplary embodiment.

An outbox system 202 may be implemented with one or more computer systems similar to the computer system 102 as described with respect to FIG. 1.

The outbox system 202 may store one or more applications that can include executable instructions that, when executed by the outbox system 202, cause the outbox system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the outbox system 202 itself, may be located in virtual server(s) running in a cloud-based computing environment rather than being tied to one or more specific physical network computing devices. Also, the application(s) may be running in one or more virtual machines (VMs) executing on the outbox system 202. Additionally, in one or more embodiments of this technology, virtual machine(s) running on the outbox system 202 may be managed or supervised by a hypervisor.

In the network environment 200 of FIG. 2, the outbox system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the outbox system 202, such as the network interface 114 of the computer system 102 of FIG. 1, operatively couples and communicates between the outbox system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the outbox system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The outbox system 202 may be a standalone device or integrated with one or more other devices or apparatuses, such as one or more of the server devices 204(1)-204(n), for example. In one particular example, the outbox system 202 may be hosted by one of the server devices 204(1)-204(n), and other arrangements are also possible. Moreover, one or more of the devices of the outbox system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the outbox system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the outbox system 202 that may efficiently provide a platform for implementing a cloud native outbox system module, but the disclosure is not limited thereto.

The client devices 208(1)-208(n) may run interface applications, such as standard web browsers or standalone client applications, which may provide an interface to communicate with the outbox system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the outbox system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the outbox system 202, the server devices 204(1)-204(n), or the client devices 208(1)-208(n), for example, may be configured to operate as virtual instances on the same physical machine. For example, one or more of the outbox system 202, the server devices 204(1)-204(n), or the client devices 208(1)-208(n) may operate on the same physical device rather than as separate devices communicating through communication network(s) 210. Additionally, there may be more or fewer outbox system 202, server devices 204(1)-204(n), or client devices 208(1)-208(n) than illustrated in FIG. 2. According to exemplary embodiments, the outbox system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

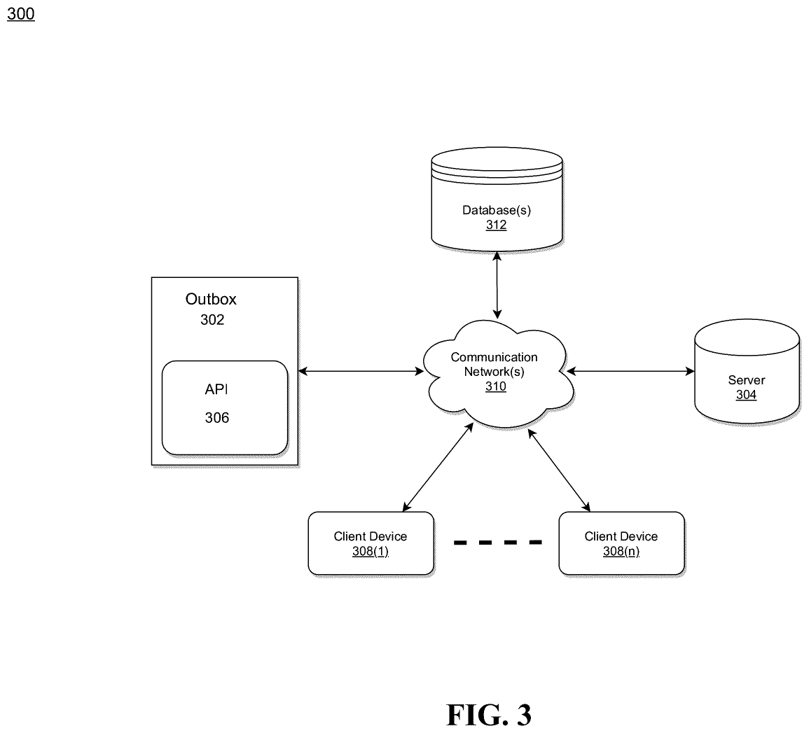

FIG. 3 illustrates a system diagram for implementing an outbox system in accordance with an exemplary embodiment.

As illustrated in FIG. 3, the system 300 may include an outbox system 302 within which a group of API modules 306 is embedded, a server 304, a database(s) 312, a plurality of client devices 308(1) . . . 308(n), and a communication network 310.

According to exemplary embodiments, the outbox system 302 including the API modules 306 may be connected to the server 304, and the database(s) 312 via the communication network 310. Although there is only one database has been illustrated, the disclosure is not limited thereto. Any number of databases may be utilized. The outbox system 302 may also be connected to the plurality of client devices 308(1) . . . 308(n) via the communication network 310, but the disclosure is not limited thereto.

According to exemplary embodiment, the outbox system 302 is described and shown in FIG. 3 as including the API modules 306, although it may include other rules, policies, modules, databases, or applications, for example. According to exemplary embodiments, the database(s) 312 may be embedded within the outbox system 302. According to exemplary embodiments, the database(s) 312 may be configured to store configuration details data corresponding to a desired data to be fetched from one or more data sources, user information data etc., but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable outbox system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the outbox system 302. In this regard, the plurality of client devices 308(1) . . . 308(n) may be “clients” of the outbox system 302 and are described herein as such. Nevertheless, it is to be known and understood that the plurality of client devices 308(1) . . . 308(n) need not necessarily be “clients” of the outbox system 302, or any entity described in association therewith herein. Any additional or alternative relationship may exist between either or both of the plurality of client devices 308(1) . . . 308(n) and the outbox system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the outbox system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The outbox system 302 may be the same or similar to the outbox system 202 as described with respect to FIG. 2, including any features or combination of features described with respect thereto.

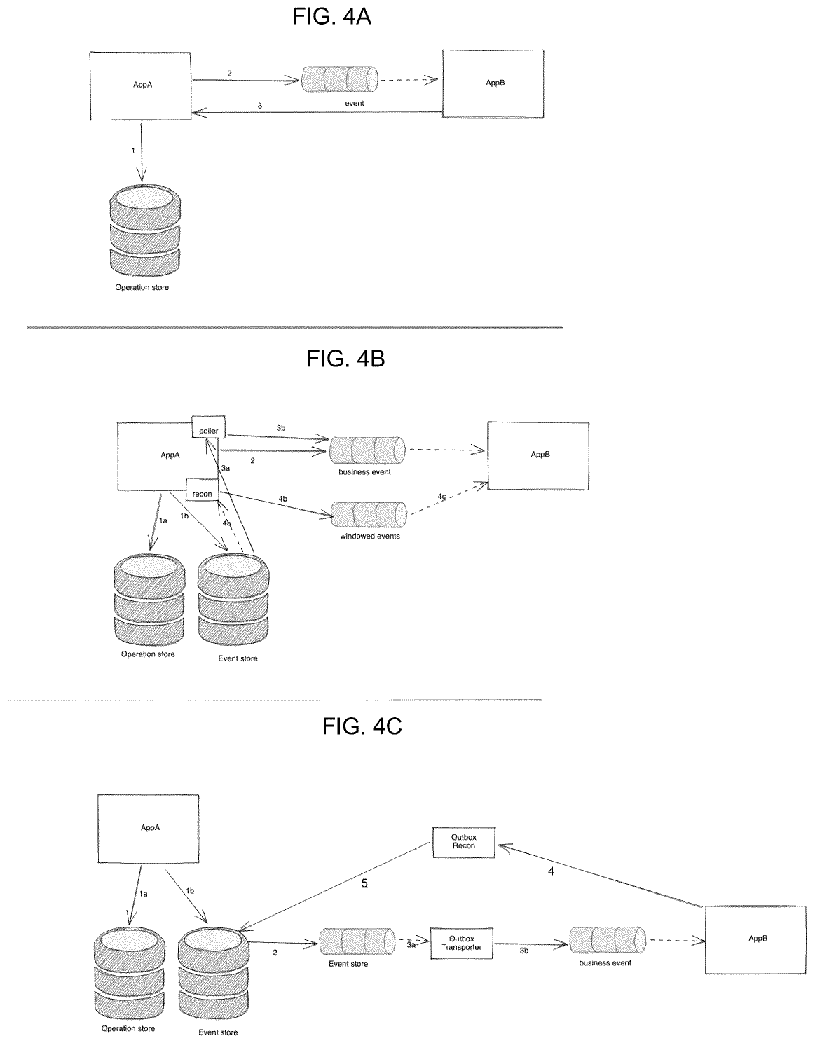

FIG. 4A illustrates a desired method to be performed to remove hard dependencies in a distributed application environment in accordance with an exemplary embodiment.

In operation 1, AppA stores data in an operation store. In operation 2, AppA communicates a corresponding event to AppB so that AppB is aware of the storing of the data by AppA. In operation 3, AppB communicates with AppA to inform AppA how many events were processed and published. In order to achieve the desired method outlined in FIG. 4A, pattern-based solutions were proposed, which is exemplarily illustrated in FIG. 4B. technology.

FIG. 4B illustrates a pattern-based solution in accordance with a related technology.

In related technology, there may be two common patterns that applications implement to address these problems, namely, Store & Forward and Transactional Outbox patterns. These patterns have six main requirements for correctness: (1) a need to transactionally commit the business record with the record to forward; (2) a need to guarantee the delivery of forwarded record; (3) a need to recon the deltas of data delivered vs. not delivered for a given time; (4) a need to re-deliver data to a target technology; (5) need to forward like-records in-order; and (6) a need to scale for normal and failure scenarios.

However, due to vast amounts of permutations of source technologies to target technologies, this leads to brittle, often-times incorrect implementations, and point-to-point solutions that do not scale for Enterprise use when there are a large number of (micro) services and engineers which must implement the patterns correctly.

In operation 1a, AppA stores data into an operation store. In operation 1b, AppA stores a corresponding event in an event store. In operation 2, AppA publishes the event to notify another application, such as AppB of the event. The pattern-based solutions may rely on publication of events and parallel storage. Generally, when a change has occurred in a distributed system, an event may be published to alert relevant parties of the occurred event. Also, the event of such change may be stored in parallel. However, when publishing events, the events may not necessarily be published in order. Accordingly, a subsequent operation may be performed before a prerequisite operation is performed due to a delayed publishing of an event that would have triggered the prerequisite operation.

In operation 3a, a poller component of AppA polls the event store and publishes any missed events. According to exemplary aspects, when AppA fails, there may be events that were generated but not yet published during the downtime. In operation 3b, the poller component of AppA then publishes any missed events to notify AppB of such events. In operation 4a, the recon component of AppA will recon the events published while AppA was down. In operation 4b, the recon events are then published to notify AppB of the reconned events.

However, polling of events may cause bottle necks whenever its system goes down, which in turn will slow down subsequent operations as downstream systems may be unaware of the events to trigger operation executions. In certain cases, if the downtime is significant, all of the events that failed to publish during the downtime will be polled all at once for publication leading to significant bottleneck. For example, if a system averages publication of 1 million events per hour, and the system is down for six hours, the system may be unable to capture and process 7 million events at the seventh hour when it goes back up. However, the application may be unable to publish such a large number of events, which will in turn lead to a large number of events that may not publish for notifying other applications of such events.

FIG. 4C illustrates a system flow diagram utilizing an outbox system in accordance with an exemplary embodiment.

As illustrated in FIG. 4C, AppA stores data into an operation store in operation 1a, and stores a corresponding event in an event store in operation 1b. According to exemplary aspects, operations 1a and 1b may be performed contemporaneously. However, aspects of the present disclosure not limited thereto, such that operation 1a is performed prior to performance of the operation 1b. Unlike the system flow illustrated in FIG. 4B, AppA only transmits or writes to the operation store and the event store, and does not receive or read information from the operation store or the event store for publishing events and/or performing a recon operation.

In operation 2, a database (DB) log tail is generated for the event store. According to exemplary aspects, DB log may include a sequential log of all of the events that were stored in the event store. The event store then streams the event that was stored in the event store to the outbox transporter in operation 3a. In operation 3b, the outbox transporter transmits the event to the App B. In operation 4, the App B communicates with the outbox reconer via an API to obtain how many events were processed and published for a given period. In operation 5, the outbox reconer communicates with the event store to determine how many events were processed and published for the given period. If the outbox reconer determines that a number of events processed corresponds or matches with a number of events published for the given period, no further action is performed or an indication of the matching numbers is communicated to the event store and/or the outbox transporter. On the other hand, if the outbox reconer determines that the number of events processed is greater than or does not match with the number of events published for the given period, the outbox reconer may identify the unpublished events and control the event store and/or the outbox transporter to publish the unpublished events so that none of the stored events are left unpublished. Further, according to exemplary aspects, each of the events may be associated with a time stamp to ensure sequential processing.

Based on such a configuration, chances of out of order publishing is reduced or eliminated by streamed event transmission. Likewise, at least since the events are streamlined to the downstream App, a risk of incurring polling bottlenecks upon resuming operation after downtime is reduced. Also, by leveraging outbox recon service, a check may be performed to ensure all of the events were processed and published to avoid a risk of having events unprocessed or unpublished.

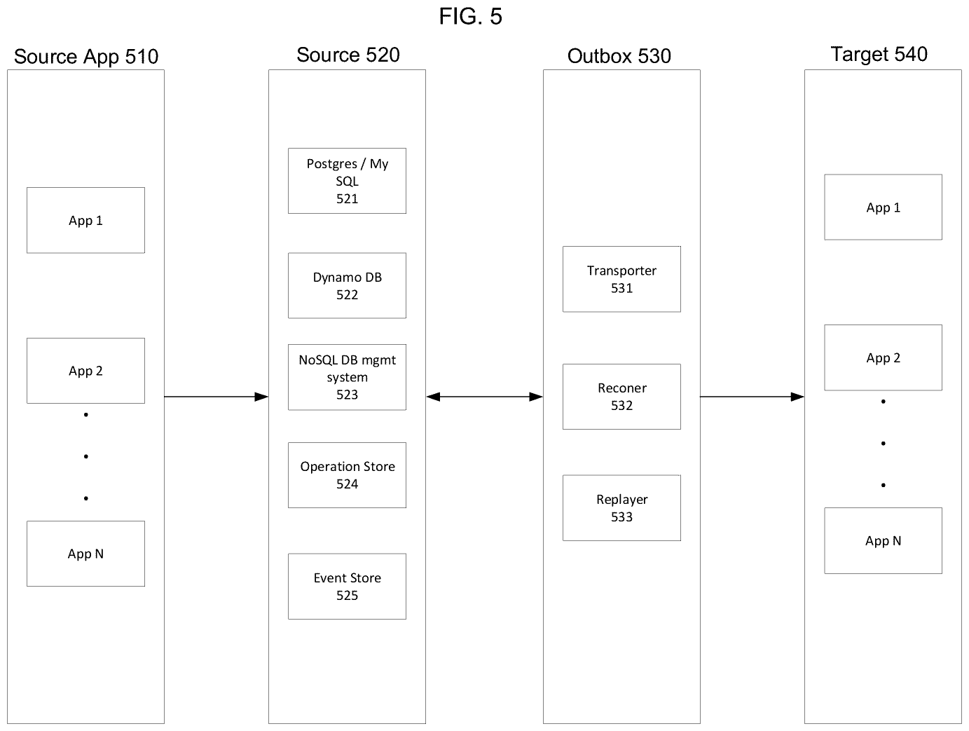

FIG. 5 illustrates a system flow diagram in a distributed application environment in accordance with an exemplary embodiment.

According to exemplary aspects, an outbox solution or system that is built-once and reused-anywhere that can adapt to the many different permutations of source to target technologies is provided. Applications in need of transactionally Store & Forwarded data can configure and plug and play the outbox solution to cater to their need. The Outbox solution provides the following capabilities: (1) transactionality—business data and outbox data exist atomically; (2) forwardability—outbox data is guaranteed for delivery; (3) replayability—outbox data is replayable from any point in time; and (4) ordered processing—outbox data is forwarded in-order for the same business record. Although four capabilities are iterated for the Outbox solution, aspects of the present disclosure are not limited thereto, such that an Outbox solution may be implemented with less or more capabilities than the ones identified.

Although patterns may be beneficial for understanding and building, they may be impractical at scale to adapt to technology landscape and variability of technologies. Libraries may be good for re-use, however, libraries are language specific and is thus, impactful to the in-line processing of the application. Further, services may be great for re-use that's language agnostic, however, services are executed out-of-line processing of the application. In contrast to the above, the outbox solution as a service may be deployed to any environment to adapt to an application's need.

A network of systems that utilizes an outbox system or solution includes a group of source apps 510, a group of sources 520, and an outbox system 530 and a group of targets 540.

The group of source apps 510 may include one or more applications that may generate an event to be forwarded for subsequent or corresponding processing. In an example, one or more of the applications (e.g., App 1, App 2 App N) included in the group of source apps 510 may execute a code or deploy a patch. For example, one or more of the applications may include an event-driven, serverless computing platform application, an elastic Kubemetes service application, a deployment and management application that distributes application workloads across a Kubernetes cluster, and the like.

The source 520 includes a postgres/mySQL 521, dynamo database (DB) 522, NoSQL DB management system 523, operation store 524 and an event store 525. Although five sources of data are described herein, aspects of the present disclosure are not limited thereto, such that more or less data sources may be present.

Once one or more of the applications included in the group of source apps 510 generates data, the generated data may be written onto the operation store 524, and a corresponding event associated with the generated data may be written onto the event store 525. In an example, events written onto the event store 525 may be sequentially written and/or with time stamp information to ensure that the events are similarly sequentially published by the outbox 530. Further, the event store 525 may include a buffer to receive multitudes of events from one or more source applications included in the group of source apps 510.

The outbox system 530 includes a transporter 531, a reconer 532, and a replayer 533. According to exemplary aspects one or more of the transporter 531, the reconer 532, and the replayer 533 may be implemented by a processor or an integrated circuit.

According to exemplary aspects of the present disclosure, the outbox system 530 provides an externalized messaging service, which is separated and independent of the source application. Such a configuration may allow the outbox system 530 to continue publishing of events stored at the event store independent of operating status of the source application. Accordingly, even if the source application is in a downed state, the outbox system 530 may continue to publish events so that a bottleneck is avoided when the source application returns to an operating state. Further, at least since the publication, polling and reoconing operations are separately performed by the outbox 530, memory and/or processing resources typically utilized by source apps may be redirected to perform application operations (e.g., running of code or patch), allowing for more application operations to be performed for more efficient processing. Accordingly, scaling of such source apps 510 may more easily or efficiently be achieved than previously.

Further, as exemplarily illustrated in FIGS. 4B and 4C, the transporter 531 is separated from the source application for independent processing of publication of events. The transporter 531 may sequentially receive or obtain events from the event store 525, and stream the received events to one or more targets included in the group of targets 540. At least since the events are retrieved or received from the event store 525, rather than from a source app, even if the source app is to incur a downtime, the events stored in the event store 525 is streamed to the one or more targets included in the group of targets 540. Accordingly, bottle neck caused by polling of events after a downtime may be reduced.

According to exemplary aspects and exemplarily illustrated in FIGS. 4B and 4C, the reconer 532 may also be separated from the source application for independent processing of recon operation. The reconer 532 may, in response to a communication signal from a target application, query the event store 525 to verify that a number of events received by the target application corresponds or matches with a number of events written to the event store 525 for a specified time period (e.g., a specific date, a particular time window on a specific date, a date range and the like). When the reconer 532 determines that the number of events processed via the event store 525 matches or corresponds to the number of events published for the specified time period, the reconer 532 may communicate with the event store 525 and/or the transporter 531 to indicate that all of the processed events have been published.

According to exemplary aspects, the replayer 533 may replay events to a destination different from a target application. In an example, the replayer 533 may select a destination of a different technology or same technology but a different topic. Accordingly, events may be replayed to other destination targets even when they may not be original intended targets.

The group of targets 540 may include one or more targets, such as App 1, App2 App N. Although applications are illustrated as being targets, aspects of the present disclosure are not limited thereto, such that targets may include a service, a data stream, a serverless event bus, and the like.

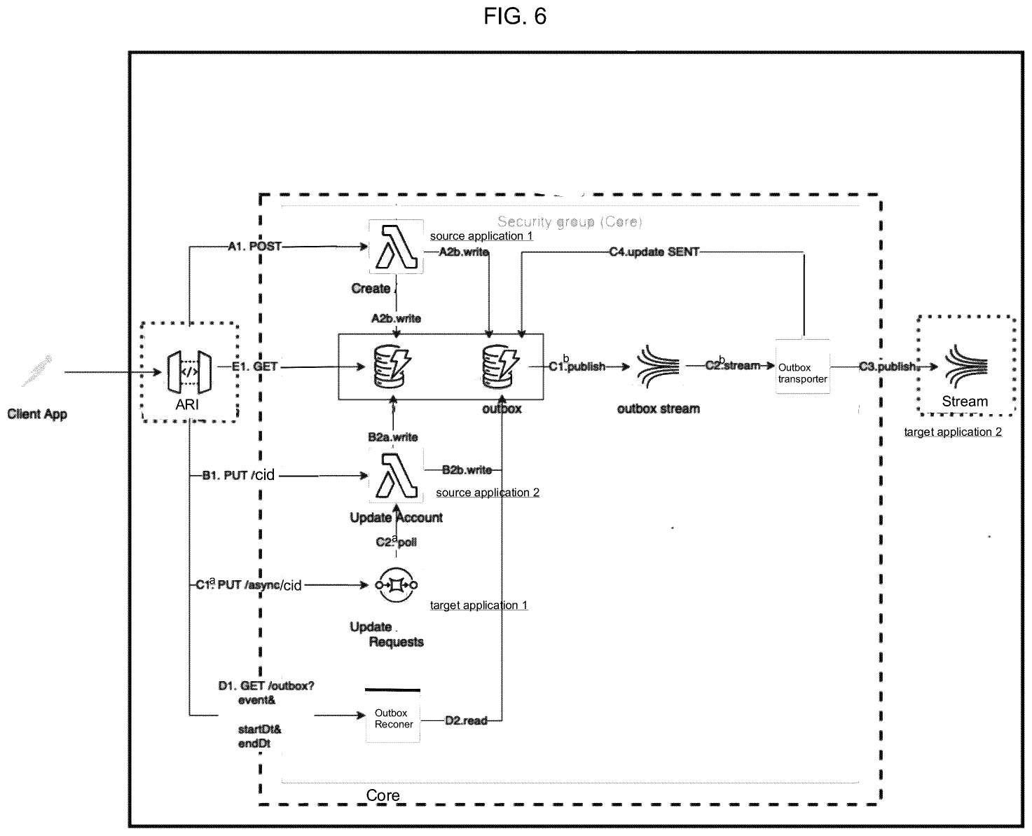

FIG. 6 illustrates a process flow for performing an outbox transportation operation in accordance with an exemplary embodiment.

In operation A1, a user may access a cloud management API to access a source application 1 on a cloud network for posting operation information. In operation A2b, the source application 1 may write the created/updated data into a source database and also write in parallel corresponding data and event into an outbox system. According to exemplary aspects, the database source may include an object store for storing of data and an event store for storing of events. The source database and the outbox system may communicate with one another.

In operation B1, the could management API may then perform a put operation for inserting the operation information into an identifier file. A source application 2 then performs operation B2a to write association of the operation information with the identifier file into the source database. In operation B2b, the source application 2 write corresponding data and event into the outbox system.

In operation C1a, the cloud management API may perform a put operation for performing an update request on a target application 1 for synchronizing operation information with an identifier of the user. In operation C2a, the target application 1 may perform a polling operation on the source application 2 to verify the number of events that were processed and published within a specified time frame (e.g., an hour, a day, or the like). In operation C1b, the events that were written into the outbox system are then published to an outbox stream. In operation C2b, the outstream streams the published event to an outbox transporter. In operation C3, the outbox transporter publishes the event to a target application 2. In operation C4, the outbox transporter sends a message back to the outbox to inform the outbox system that the event has been published to the target application. The outbox system may then write an event to the outbox system indicating publishing the event to the target application 2.

In operation D1, the cloud management API may request an outbox reconer to perform a get operation for obtaining a number of events that were processed and published within a specified time frame. For example, the request may specify to obtain a number of events that were processed and published by the outbox system for a specified time range. In operation D2, the outbox reconer performs a read operation of the outbox system for obtaining the requested information. For example, the outbox reconer may read that 100 events were processed and 100 events were published, indicating that all events were published. In another example, the outbox reconer may read that 100 events were processed but only 90 were published, indicating that 10 events were not published. In such a scenario the outbox reconer may identify the non-published events and publish such events in a sequential order. At least since the events may utilize database log tailing with time stamp information, a sequential order of events may be indicated. Accordingly, out of order publication may be avoided, which may be problematic in a pattern-based method as exemplarily illustrated in FIG. 4B.

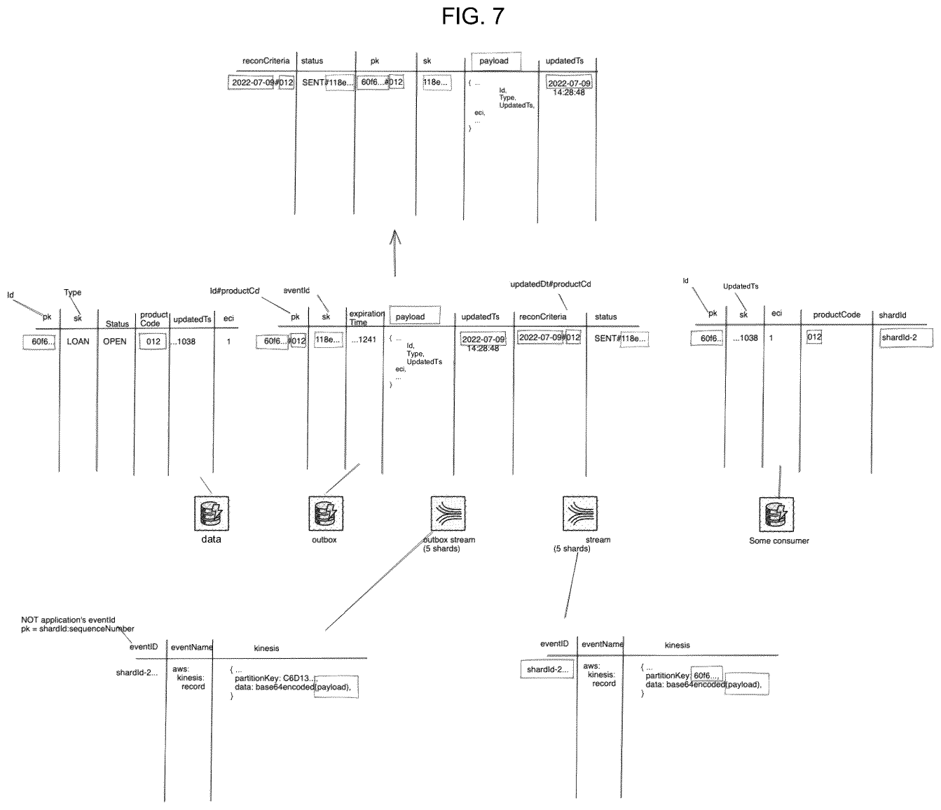

FIG. 7 illustrates a process flow for performing an outbox recon operation in accordance with an exemplary embodiment.

According to exemplary aspects, a primary key (pk) may be utilized to aggregate events for a certain record identifier. Further, a sort key (sk) may be utilized for identifying sequential order of the events for the respective primary key.

As exemplarily provided in FIG. 7, the outbox reconer may access various source databases and outbox systems for aggregating all of the processed events and published events for a specified time period. Further, all of the events processed and published for may be specified for a particular product code. However, aspects of the present disclosure are not limited thereto, such that processed and published events may be identified for different criteria.

For example, recon criteria may specify a product code of 012 for the date of Jul. 9, 2022. As illustrated in FIG. 7, product code 012 is indicated as being associated with a pk of 6016 . . . , which may be a record identifier, in the source database. In the outbox system, pk may tie in the identifier with the product code, which may also indicate an event identifier as the sk, along with time stamp information, status information and recon criteria information. The identifier may also be associated with a unique identifier of a shard within a stream, such as a shardid.

The outbox reconer may also access various streams, such as outbox stream with multiple shards (e.g., 5 shards) and a stream with multiple shards (e.g., 5 shards). The data stored in the outbox stream may indicate a payload associated with the shardid and the identifier.

Based on all of the accessed information, the outbox reconer may be able to aggregate relevant information corresponding to the recon criteria specified, such as status, pk, sk, payload and updated time stamp information.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for providing outbox services separate from a source application in a distributed application system, the method comprising:
performing, by the source application, an operation;
writing, onto an operation store, data associated with the operation performed by the source application;
writing, onto an event store, an event corresponding to the data to the data stored in the operation store;
receiving, by an outbox transport processor and from the event store, the event;
publishing, to a target and by the outbox transport processor, the event received by the outbox transport processor,
wherein the outbox transport processor is separate from the source application;
in response to receiving the event by the target, transmitting a query to an outbox recon processor, the query requesting a number of events written to the event store and a number of events published during a specified time period,
wherein the outbox recon processor is separate from the source application;
comparing the number of events written to the event store and the number of events published during the specified time period; and
when the number of events published does not match with the number of events written for the specified time period,
identifying one or more events that were not published and controlling the outbox transport processor to publish the one or more events, and
controlling the outbox transport processor to publish the one or more events identified by the outbox recon processor.

2. (canceled)

3. (canceled)

4. The method according to claim 1, further comprising:
controlling an outbox replay processor to replay one or more events stored in the event store to the target.

5. The method according to claim 1, wherein the event received by the outbox transport processor is streamed to the target in a sequential manner.

6. The method according to claim 1, wherein the event is written to the event store in a sequential manner with time stamp information.

7. The method according to claim 6, wherein the event is published in a sequential manner according to the time stamp information associated with the event.

8. The method according to claim 1, wherein the source application does not receive or read information from the event store.

9. The method according to claim 1, wherein the source application does not receive or read information from the operation store.

10. The method according to claim 1, wherein the event store has a buffer for receiving a plurality of events to the event store, and the outbox transport processor sequentially publishes one event at a time in a stream.

11. A system to provide outbox services separate from a source application in a distributed application system, the system comprising:
a computer including a processor;
the source application that performs an operation via the processor of the computer;
an operation store that stores data associated with the operation performed by the source application;
an event store that stores an event corresponding to the data stored in the operation store;
an outbox transport processor that;
receives, from the event store, the event; and
publishes, to a target, the received event,
wherein the outbox transport processor is separate from the source application;
in response to receiving the event by the target, transmitting a query to an outbox recon processor, the query requesting a number of events written to the event store and a number of events published during a specified time period,
wherein the outbox recon processor is separate from the source application;
comparing the number of events written to the event store and the number of events published during the specified time period; and
when the number of events published does not match with the number of events written for the specified time period,
identifying one or more events that were not published and controlling the outbox transport processor to publish the one or more events, and
controlling the outbox transport processor to publish the one or more events identified by the outbox recon processor.

12. (canceled)

13. (canceled)

14. The system according to claim 11, further comprising:
an outbox replay processor that replays one or more events stored in the event store to the target.

15. The system according to claim 11, wherein the event received by the outbox transport processor is streamed to the target in a sequential manner.

16. The system according to claim 11, wherein the event is written to the event store in a sequential manner with time stamp information.

17. The system according to claim 16, wherein the event is published in a sequential manner according to the time stamp information associated with the event.

18. The system according to claim 11, wherein the source application does not receive or read information from the event store.

19. The system according to claim 11, wherein the source application does not receive or read information from the operation store.

20. The system according to claim 11, wherein the event store has a buffer for receiving a plurality of events to the event store, and the outbox transport processor sequentially publishes one event at a time in a stream.
